(19) United States
(12) Patent Application Publication
(10) Pub. No.: US 2016/0357800 A1
(43) Pub. Date: Dec. 8, 2016

(54) NETWORK SWITCH AND DATA BASE UPDATING METHOD

(71) Applicant: MEDIATEK INC., Hsin-Chu (TW)

(72) Inventors: Shu-Ping Lin, New Taipei City (TW); Chien-Cheng Chiang, Taipei City (TW)

(21) Appl. No.: 14/944,237

(22) Filed: Nov. 18, 2015

Related U.S. Application Data
(60) Provisional application No. 62/170,704, filed on Jun. 4, 2015.

(51) Int. Cl. G06F 17/30; H04L 12/24; G06N 99/00

(52) U.S. Cl. CPC G06F 17/30345; G06N 99/005; H04L 41/16

(57) ABSTRACT

A network switch comprising: a first data transmitting module, configured to receive first input data and to generate a first updating request based on first updating information, wherein the first updating request indicates which address of data base stored in a storage unit is requested to be updated; and a first monitoring module, configured to modify the first updating information according to the first updating request.

### CROSS REFERENCE TO RELATED APPLICATIONS

This application claims the benefit of U.S. Provisional Application No. 62/170,704, filed on Jun. 4, 2015, the contents of which are incorporated herein by reference.

### BACKGROUND

A network switch is applied to transmit data between a plurality of electronic apparatuses. The network switch keeps learning (updating) relations between MAC (Media Access Control) addresses and pipe line modules (ex. a port), such that the network switch can efficiently transmit data to a required destination. Specifically, the network switch keeps learning (updating) relations between MAC addresses and pipe line modules to generate a MAC address table, and the network switch searches the MAC address table to find the pipe line module corresponding to the required destination.

The MAC address table needs to be continuously updated such that the data transmitting efficiency can be optimized. However, in related art the requests for updating the MAC address table all line up to wait for processing. Such mechanism needs much time to process the updating requests and the addresses for the MAC address table which are requested to be updated may conflict. Such confliction causes more time for processing the updating requests. Accordingly, the learning rate is low.

If the learning rate is low and no suitable control mechanism is applied, a “data hazard” issue or a “multiple instance” issue may occurs. For example, if a relation between a pipe line module and a MAC address is desired to be updated, the related data region will be read and updated to new one. However, if the related data is read by a first pipe line module and read by a second pipe line module before the first pipe line module updates the related data, the data hazard issue occurs. Further, the “multiple instance” issue means the same key exists in different pipe line systems with different pipe line system information, since the MAC address table is not efficiently updated.

### SUMMARY

Accordingly, one objective of the present application is to provide a network switch which can increase the learning rate.

Another objective of the present application is to provide a data base updating method which can increase the learning rate.

One embodiment of the present application provides a network switch comprising: a first data transmitting module, configured to receive first input data and to generate a first updating request based on first updating information, wherein the first updating request indicates which address of database stored in a storage unit is requested to be updated; and a first monitoring module, configured to modify the first updating information according to the first updating request.

Another embodiment of the present application provides a network switch comprising: a first die, configured to generate first die updating request; a second die, configured to generate second die updating request; a data transmitting module, configured to receive the first die updating request and the second die updating request; and an arbitrating module, configured to generate an arbitrating command to allocate data base addresses to be updated for a data base according to the first die updating request and the second die updating request.

Data base updating methods can be acquired based on above-mentioned embodiments. Detail steps for the methods can be acquired based on above-mentioned contents, thus are omitted for brevity here.

In view of the above-mentioned embodiments, the learning rate of the network switch can be increased since the network switch has a hierarchical structure, thus the data hazard issue and the multiple instance issue can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a network switch according to one embodiment of the present application.

FIG. 2 is a schematic diagram illustrating how to update a MAC address table according to one embodiment of the present application.

FIG. 3-FIG. 10 are block diagrams illustrating network switches according to different embodiments of the present application.

### DETAILED DESCRIPTION

In the following, several embodiments are provided to explain the concept of the present application. Please note, in the following embodiments, the operations for the network switch can be controlled by a control unit or any device that can control the network switch. Further, in the following embodiments, all devices can be implemented by hardware (ex. a circuit) or hardware with software (ex. processing unit executing a specific program).

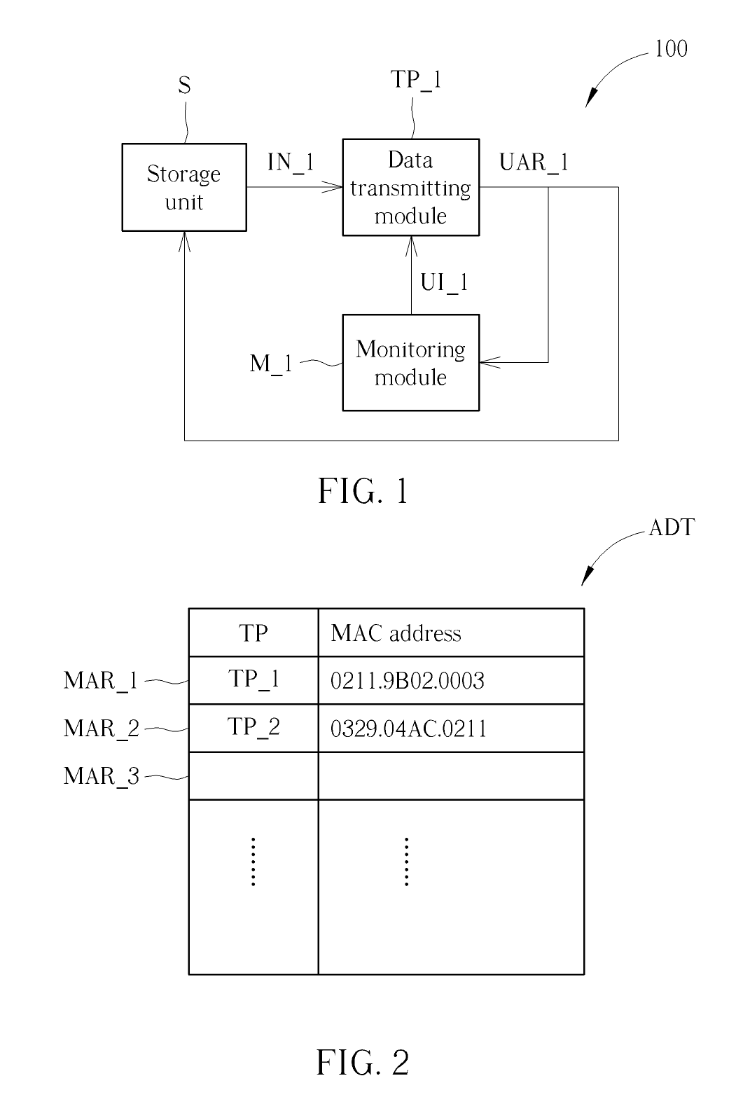

FIG. 1 is a block diagram illustrating a network switch according to one embodiment of the present application. As illustrated in FIG. 1, the network switch 100 comprises a first data transmitting module TP_1 and a first monitoring module M_1. The first data transmitting module TP_1 is configured to receive first input data IN_1 and to generate a first updating request UAR_1 based on first updating information UI_1. The first input data IN_1 is from data base stored in the storage unit S (ex. a SRAM). The first updating request UAR_1 indicates which address of the data base is requested to be updated (i.e. the data address to be updated). The first monitoring module M_1 is configured to modify the first updating information UI_1 according to the first updating request UAR_1.

In one embodiment, the data base stored in the storage unit S is a MAC address table. The first data transmitting module TP_1 is a pipe line module such as a port. The first updating information UI_1 indicates which addresses of the data base have been updated by the first data transmitting module TP_1. However, these examples do not mean to limit the scope of the present application.

FIG. 2 is a schematic diagram illustrating how to update a MAC address table according to one embodiment of the present application. As illustrated in FIG. 2, the MAC address table ADT (Address Table) comprises data regions MAR_1 and MAR_2, which respectively records relations between MAC addresses and different data transmitting modules. Also, the MAC address table ADT further comprises a data region MAR_3, which is empty.

In one example, the data transmitting module TP_1 generates the first updating request UAR_1 to request establishing a new relation between a MAC address and a data transmitting module in the data region MAR_3. In such case, the first monitoring module M_1 records that the data region MAR_3 has been occupied and correspondingly updates the first updating information UI_1. Thus, if the data transmitting module TP_1 requests establishing a new relation between a MAC address and a data transmitting module again next time, the data transmitting module TP_1 will know the data region MAR_3 is already occupied via the first updating request UI_1 and will request another data region.

In one embodiment, the relation between the data transmitting module and the MAC address will be cleaned if no data is received in a predetermined time interval. Take FIG. 2 for example, if no data has been transmitted from an electronic apparatus with the MAC address 0211.9B02.0003 in a predetermined time interval, the relation recorded in the data region MAR_1 will be cleaned.

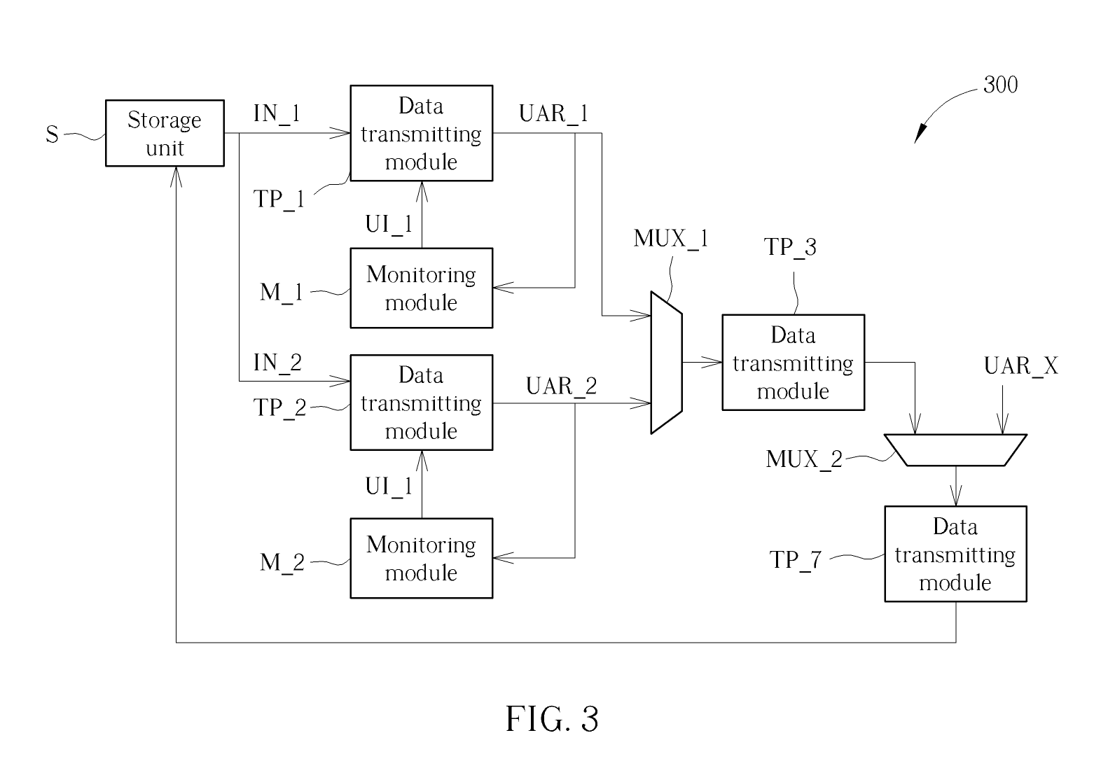

The number of the data transmitting module and the monitoring module is not limited to one. FIG. 3 is a block diagram illustrating a network switch according to one embodiment of the present application. AS illustrated in FIG. 3, the network switch 300 further comprises a second data transmitting module TP_2 and a second monitoring module M_2 besides the first data transmitting module TP_1 and the monitoring module M_1. The second data transmitting module TP_2 is configured to generate a second updating request UAR_2, and the second monitoring module M_2 is applied to generate a second updating information UI_2. Detail operations for the second data transmitting module TP_2 and a second monitoring module M_2 are similar with the operations for the first data transmitting module TP_1 and the second monitoring module M_1, thus are omitted for brevity here.

In one embodiment, the network switch 300 further comprises multiplexers MUX_1 and MUX_2, a third transmitting module TP_3 and another transmitting module TP_7. The third transmitting module TP_3 receives one of the first updating request UAR_1 and the second updating request UAR_2 via the multiplexer MUX_1. Further, the transmitting module TP_7 receives one of the first updating request UAR_1, the second updating request UAR_2 and external updating request UAR_x from another source via the multiplexer MUX_2. In such case, the database is updated according to one of the first updating request UAR_1, the second updating request UAR_1 and the external updating request UAR_x. Please note the term “external” here is only for the convenience of identifying and does not mean the external updating request UAR_x comes from an external electronic device.

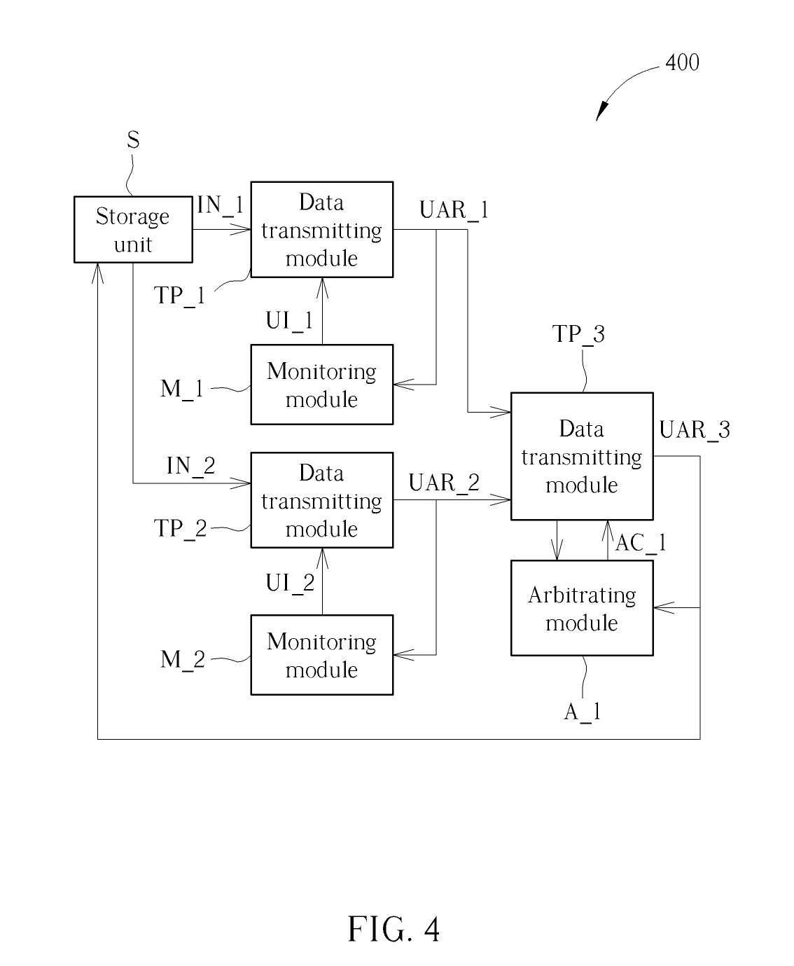

FIG. 4 is a block diagram illustrating a network switch according to one embodiment of the present application. As illustrated in FIG. 4, the network switch 400 further comprises a first arbitrating module A_1 besides the devices illustrated in FIG. 3. In FIG. 3, the third data transmitting module TP_3 receives either the first updating request UAR_1 or the second updating request UAR_2 by selection of multiplexer MUX_1. However, in FIG. 4, the first arbitrating module A_1 can be used to arrange both the first updating request UAR_1 and the second updating request UAR_2. The first arbitrating module A_1 is configured to generate a first arbitrating command AC_1, which is applied to update the data base, according to the first updating request UAR_1 and the second updating request UAR_2. More specifically, the third data transmitting module TP_3 generates a third updating request UAR_3 according to the first arbitrating command AC_1, and the data base is updated according to the third updating request UAR_3.

For more detail, the first arbitrating module A_1 is applied to arbitrate the first data transmitting module TP_1 and the second data transmitting module TP_2 if the first data transmitting module TP_1 and the second data transmitting module TP_2 request the same data base addresses to be updated. Take FIG. 2 for example, if the first data transmitting module TP_1 and the second data transmitting module TP_2 request the data region MAR_2 of FIG. 2 to update, the first arbitrating module A_1 will select one of the first data transmitting module TP_1 and the second data transmitting module TP_2 to use the data region MAR_2 and informs the other one data transmitting module to select another address.

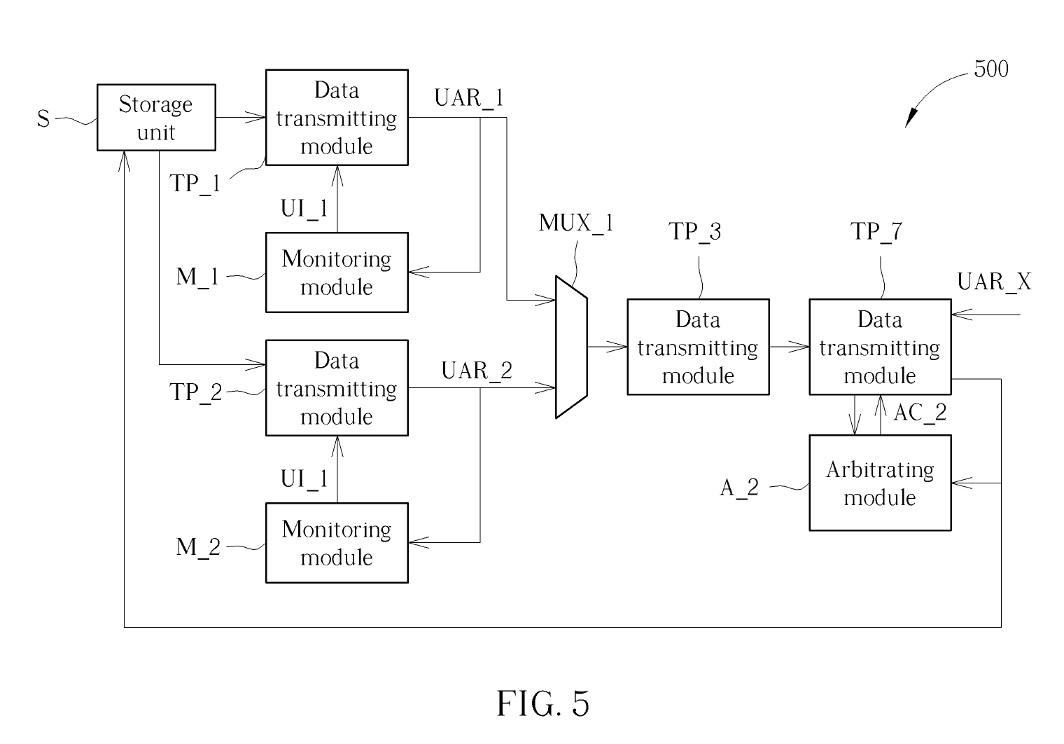

FIG. 5 is a block diagram illustrating a network switch according to one embodiment of the present application. Structures for the first data transmitting module TP_1, the first monitoring module M_1, the second data transmitting module TP_2, the second monitoring module M_2, the multiplexer MUX_1 and the third data transmitting module TP_3 are the same as which of FIG. 3, thus is omitted for brevity here. The network switch 500 in FIG. 5 further comprises a seventh data transmitting module TP_7 and a second arbitrating module A_2. The second arbitrating module A_2 is configured to generate a second arbitrating command AC_2 according to an external updating request UAR_x and one of the first updating request UAR_1 and the second updating request UAR_2. The second arbitrating command AC_2 is applied to update the database. The examples of the external updating request UAR_x will be described later.

The function of the second arbitrating command AC_2 is similar with the first arbitrating command AC_1 illustrated in FIG. 4. If the first updating request UAR_1 or the second updating request UAR_2, which is received by the seventh data transmitting module TP_7, requests a data base address to be updated the same as which of the external updating request UAR_x, the second arbitrating command AC_2 will transmit a second arbitrating command AC_2 to inform the first data transmitting module TP_1 or the second data transmitting module TP_2, or the data transmitting module which generates the external updating request UAR_x to select different data base addresses. More specifically, the seventh data transmitting module TP_7 generates a seventh updating request UAR_7 according to the second arbitrating command AC_1, and the data base is updated according to the seventh updating request UAR_7.

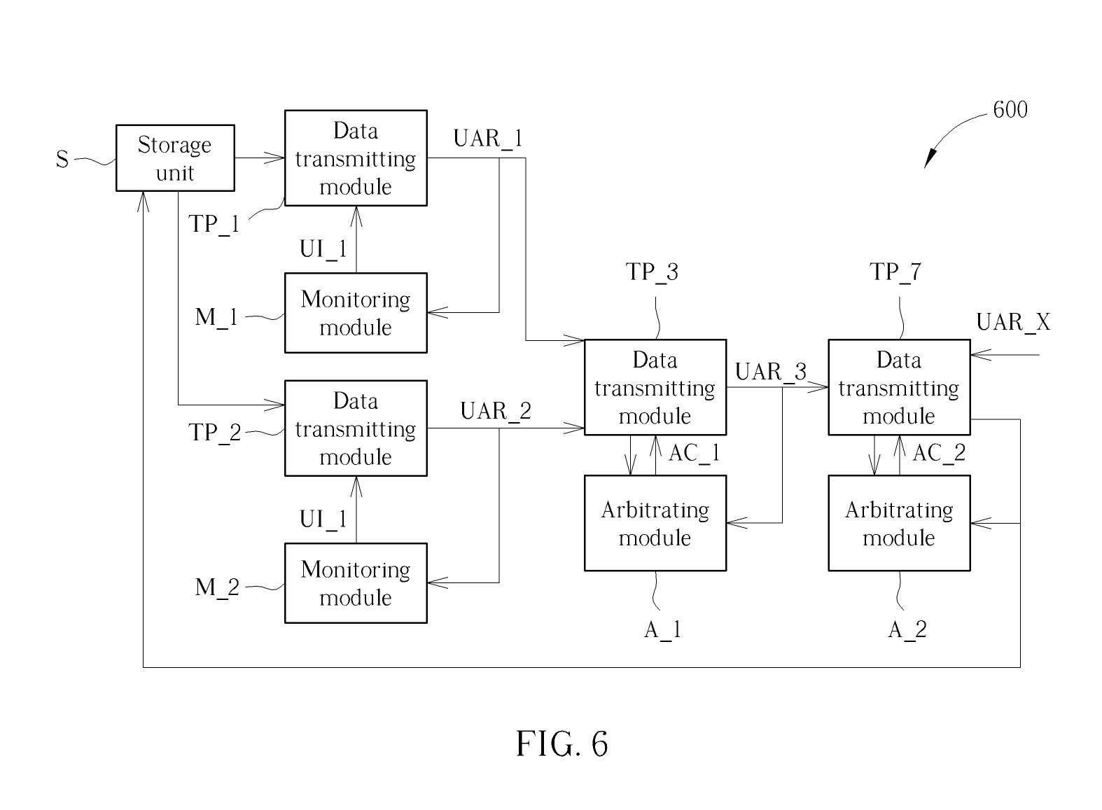

FIG. 6 is a block diagram illustrating a network switch according to one embodiment of the present application. Compared with the embodiment of FIG. 5, the network switch 600 in FIG. 6 further comprises the first arbitrating module A_1. In such case, the first arbitrating module A_1 checks if the first updating request UAR_1 and the second updating request UAR_2 request the same data base address to be updated, and the third data transmitting module TP_3 generates a third updating request UAR_3 according to the first arbitrating module A_1. After that, the second arbitrating module A_2 checks if the third updating request UAR_3 and the external updating request UAR_x request the same data base address to be updated, and then generates the second arbitrating command AC_2 to allocate data base addresses to be updated.

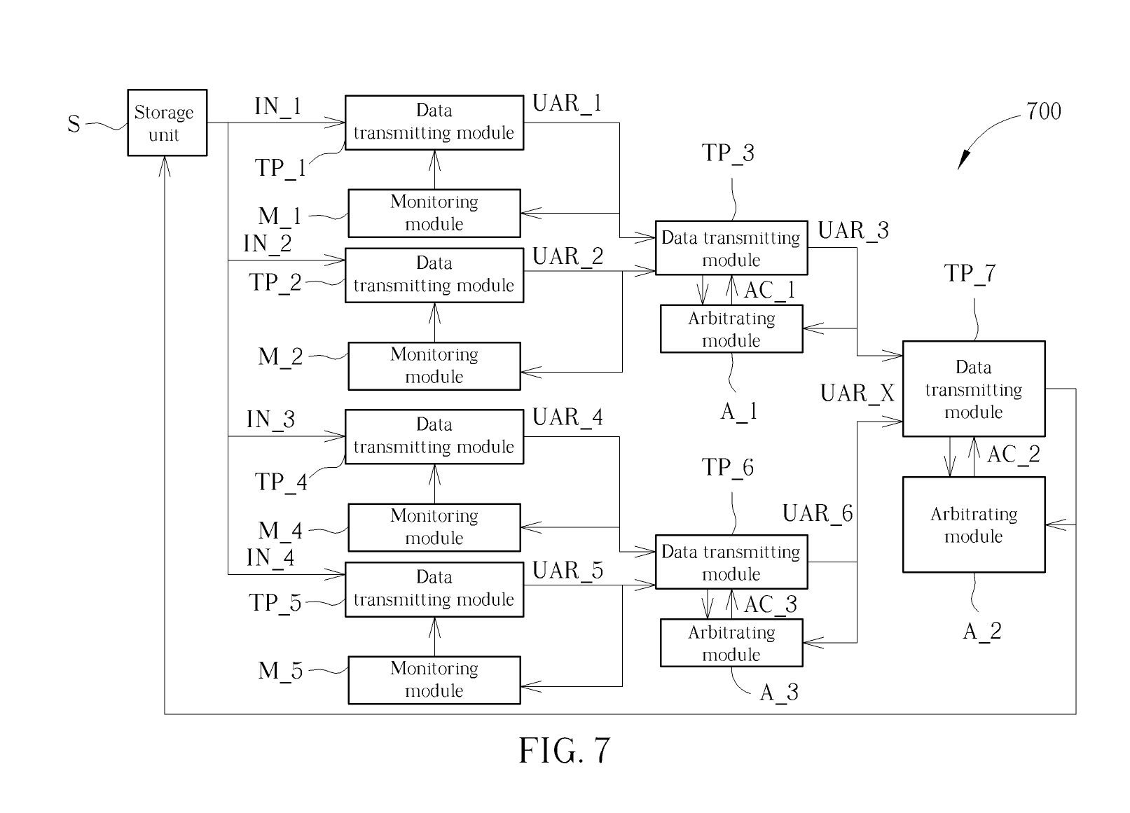

FIG. 7 is a block diagram illustrating a network switch according to one embodiment of the present application. Compared with the embodiment illustrated in FIG. 6, the network switch 700 illustrated in FIG. 7 further comprises a fourth data transmitting module TP_4, a fourth monitoring module M_4, a fifth data transmitting module TP_5, a fifth monitoring module M_5, a sixth data transmitting module TP_6 and a third arbitrating module A_3. The structure and the operation of the fourth data transmitting module TP_4, the fourth monitoring module M_4, the fifth data transmitting module TP_5, the fifth monitoring module M_5, the sixth data transmitting module TP_6 and the third arbitrating module A_3 are the same as which of the first data transmitting module TP_1, the first monitoring module M_1, the second data transmitting module TP_2, the second monitoring module M_2, the third data transmitting module TP_3 and the first arbitrating module A_1 illustrated in FIG. 6, thus related descriptions are omitted for brevity here.

In the embodiment of FIG. 7, the external updating request UAR_X is the sixth updating request UAR_6 generated by the sixth data transmitting module TP_6. Therefore, the second arbitrating module A_2 generates a second arbitrating command AC_2 according to the first updating request UAR_1, the second updating request UAR_2, the fourth updating request UAR_4 and the fifth updating request UAR_5.

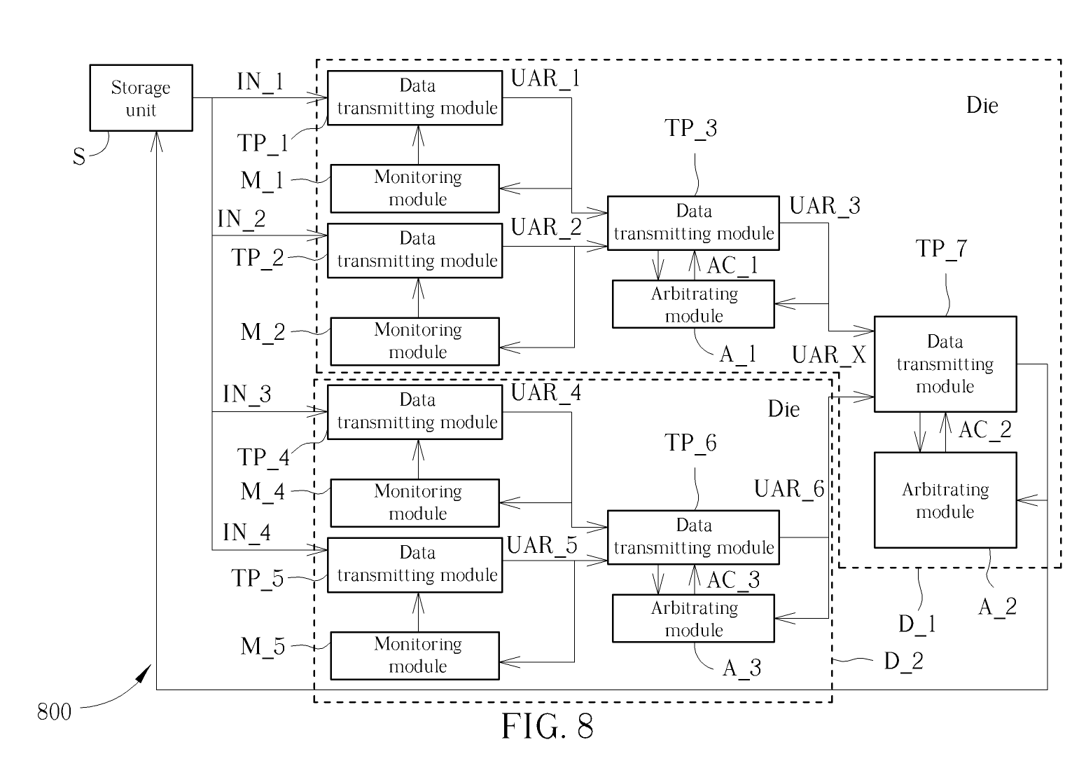

The devices for the network switch of the present application can be provided in different dies. FIG. 8 is a block diagram illustrating a network switch according to one embodiment of the present application, which corresponds to the embodiment of FIG. 7. In the embodiment of FIG. 8, the first data transmitting module TP_1, the first monitoring module M_1, the second data transmitting module TP_2, the second monitoring module M_2, the third data transmitting module TP_3 and the first arbitrating module A_1 are provided in the first die D_1. Also, the fourth data transmitting module TP_4, the fourth monitoring module M_4, the fifth data transmitting module TP_5, the fifth monitoring module M_5, the sixth data transmitting module TP_6 and the third arbitrating module A_3 are provided in the second die D_2.

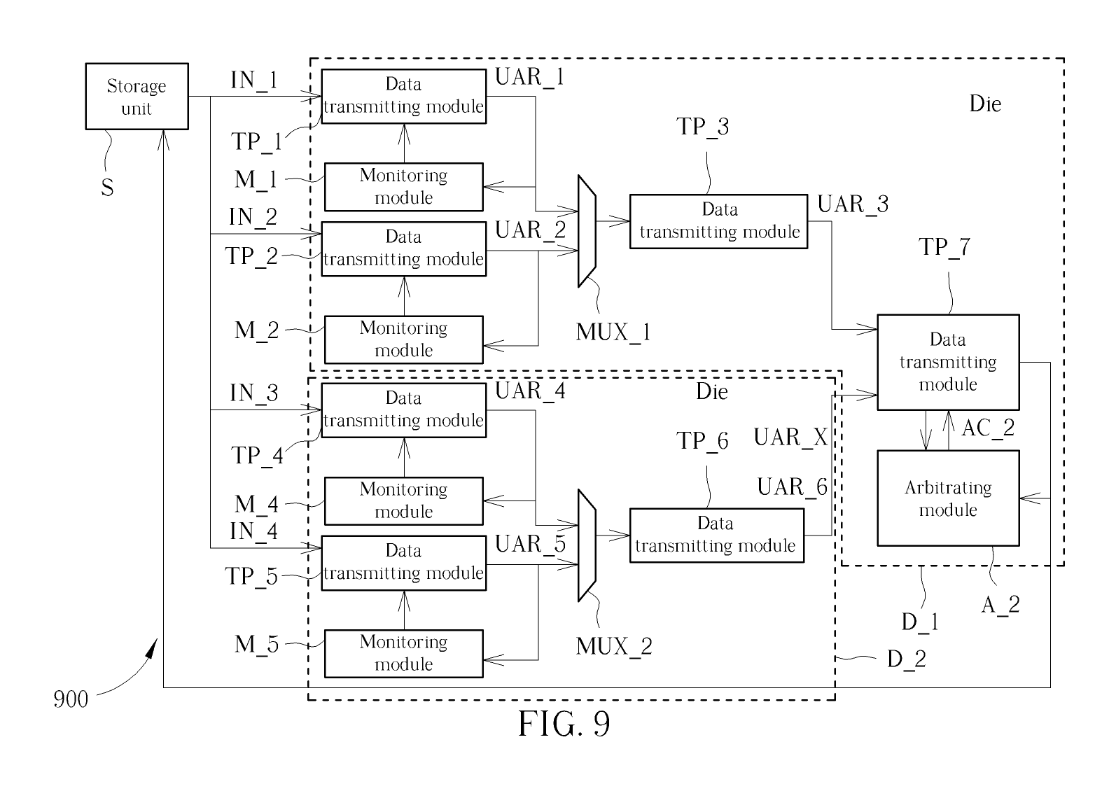

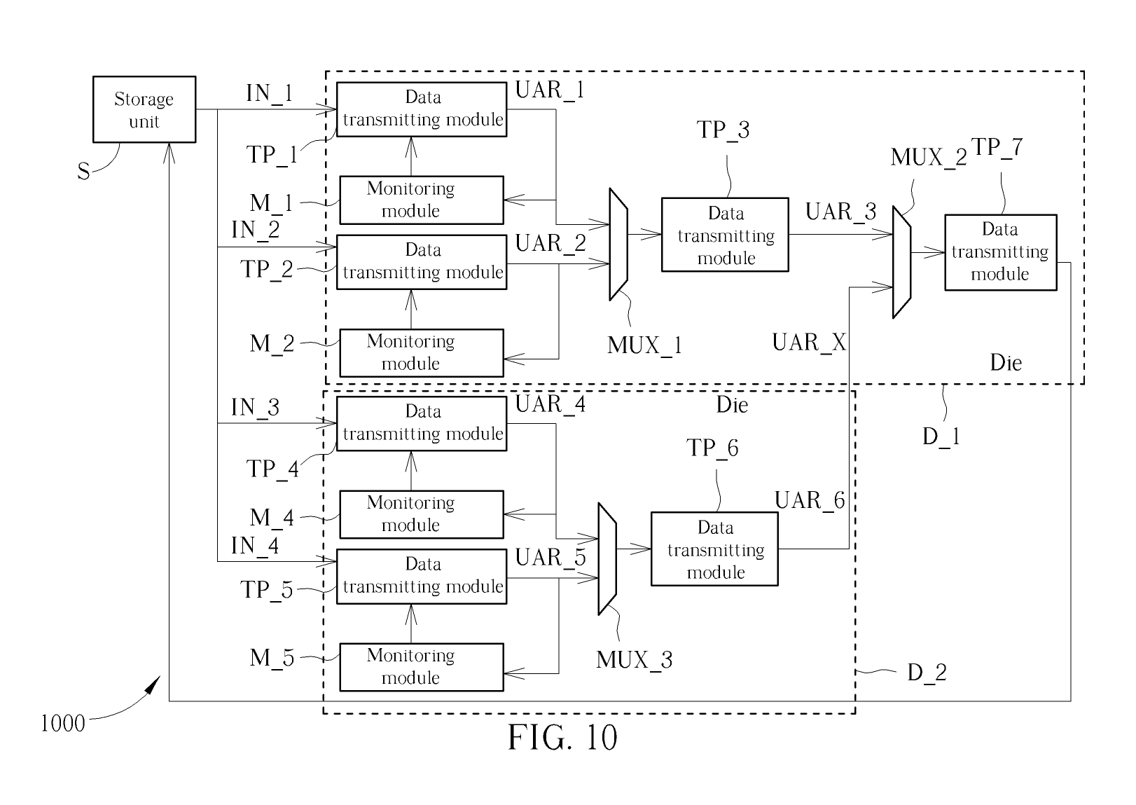

FIG. 9 is a block diagram illustrating a network switch according to one embodiment of the present application, which corresponds to the embodiment of FIG. 5. Compared with the embodiment of FIG. 5, the network switch 900 further comprises a fourth data transmitting module TP_4, a fourth monitoring module M_4, a fifth data transmitting module TP_5 and a fifth monitoring module M_5. Also, the external updating request UAR_x in FIG. 5 is one of the third updating request UAR_3 and the fourth updating request UAR_4. Therefore, the second arbitrating module A_2 in FIG. 9 generates the second arbitrating command AC_2 to update the data base according to one of the first updating request UAR_1, the second updating request UAR_2, and one of the fourth updating request UAR_4, the fifth updating request UAR_5. In such embodiment, the first data transmitting module TP_1, the first monitoring module M_1, the second data transmitting module TP_2, the second monitoring module M_2, and the third data transmitting module TP_3 are provided in the first die D_1. Also, the fourth data transmitting module TP_4, the fourth monitoring module M_4, the fifth data transmitting module TP_5, the fifth monitoring module M_5, and the sixth data transmitting module TP bare provided in the second die D_2.

FIG. 10 is a block diagram illustrating a network switch according to one embodiment of the present application, which corresponds to the embodiment of FIG. 3. Compared with the embodiment of FIG. 3, the network switch 1000 further comprises a fourth data transmitting module TP_4, a fourth monitoring module M_4, a fifth data transmitting module TP_5 and a fifth monitoring module M_5. In such embodiment, the first data transmitting module TP_1, the first monitoring module M_1, the second data transmitting module TP_2, the second monitoring module M_2, and the third data transmitting module TP_3 are provided in the first die D_1. Also, the fourth data transmitting module TP_4, the fourth monitoring module M_4, the fifth data transmitting module TP_5, the fifth monitoring module M_5, and the sixth data transmitting module TP bare provided in the second die D_2.

It will be appreciated that the seventh data transmitting module TP_7 and the second arbitrating module A_2 in the embodiments of FIG. 8, FIG. 9 and FIG. 10 can be provided in the second die D_2 as well, or be provided at any location besides the first die D_1 and the second die D_2.

The embodiments illustrated in FIG. 8-FIG. 10 can be summarized as: A network switch, comprising: a first die, configured to generate first die updating request; a second die, configured to generate second die updating request; a data transmitting module (ex. the seventh data transmitting module TP_7), configured to receive the first die updating request and the second die updating request; and an arbitrating module (ex. the second arbitrating module A_2), configured to generate an arbitrating command to allocate data base updating address for a data base according to the first die updating request and the second die updating request.

The first die updating request indicates the updating request generated in the first die D_1 and received by the seventh data transmitting module TP_7. For example, in the embodiment of FIG. 8, the first die updating request is the third updating request UAR_3. In the embodiments of FIG. 9 and FIG. 10, the first die updating request is the first updating request UAR_1 or the second updating request UAR_2. Similarly, the second die updating request indicates the updating request generated in the second die D_2 and received by the seventh data transmitting module TP_7.

In view of above-mentioned embodiments, a data base updating method can be acquired, which comprises the steps of: generating a first updating request (ex. UAR_1 in FIG. 1) based on first updating information (ex. UI_1 in FIG. 1), wherein the first updating request indicates which address of data base stored in a storage unit is requested to be updated; and modifying the first updating information according to the first updating request

In view of above-mentioned embodiments, another data base updating method can be acquired, which comprises following steps:
acquiring first die updating request for a first die (ex. D_1 in FIG. 8, FIG. 9, FIG. 10) and a second die updating request for a second die (ex. D_2 in FIG. 8, FIG. 9, FIG. 10); and generating an arbitrating command (ex. UAR_7 in FIG. 8, FIG. 9, FIG. 10) to allocate data base addresses to be updated for a data base according to the first die updating request and the second die updating request.

Please note, the number and the arrangement for all devices in the network switch provided by the present application are not limited above-mentioned embodiments.

In view of the above-mentioned embodiments, the learning rate of the network switch can be increased since the network switch has a hierarchical structure, thus the data hazard issue and the multiple instance issue can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network switch, comprising:
a first data transmitting module, configured to receive first input data and to generate a first updating request based on first updating information, wherein the first updating request indicates which address of data base stored in a storage unit is requested to be updated; and
a first monitoring module, configured to modify the first updating information according to the first updating request.

2. The network switch of claim 1, further comprising:
a second data transmitting module, configured to receive second input data and to generate a second updating request based on second updating information;
a second monitoring module, configured to modify the second updating information according to the second updating request;
a third data transmitting module, configured to receive the first updating request and the second updating request; and
a first arbitrating module, configured to generate a first arbitrating command according to the first updating request and the second updating request;
wherein the first arbitrating command is applied to update the data base.

3. The network switch of claim 2, wherein the third data transmitting module generates a third updating request according to the first arbitrating command, further comprising:
a seventh data transmitting module, configured to receive the third updating request; and
a second arbitrating module, configured to generate a second arbitrating command according to the third updating request and an external updating request;
wherein the second arbitrating command is applied to update the data base.

4. The network switch of claim 3, further comprising:
a fourth data transmitting module, configured to receive fourth input data and to generate a fourth updating request based on fourth updating information;
a fourth monitoring module, configured to modify the fourth updating information according to the fourth updating request;
a fifth data transmitting module, configured to receive fifth input data and to generate a fifth updating request based on fifth updating information;
a fifth monitoring module, configured to modify the fifth updating information according to the fifth updating request;
a sixth data transmitting module, configured to receive the fourth updating request and the fifth updating request to generate the external updating request according to a third arbitrating command; and
a third arbitrating module, configured to generate the third arbitrating command according to the fourth updating request and the fifth updating request.

5. The network switch of claim 4, comprising:
a first die;
a second die;
wherein the first data transmitting module, the first monitoring module, the second data transmitting module, the second monitoring module, the third data transmitting module and the first arbitrating module are provided in the first die;
wherein the fourth data transmitting module, the fourth monitoring module, the fifth data transmitting module, the fifth monitoring module, the sixth data transmitting module, and the third arbitrating module are provided in the second die.

6. The network switch of claim 1, further comprising:
a second data transmitting module, configured to receive second input data and to generate a second updating request based on second updating information;
a second monitoring module, configured to modify the second updating information according to the second updating request;
a third data transmitting module, configured to receive one of the first updating request and the second updating request; and
a second arbitrating module, configured to generate a second arbitrating command according to an external updating request and one of the first updating request and the second updating request;
wherein the second arbitrating command is applied to update the data base.

7. The network switch of claim 6, comprising:
a first die;
a second die;
a fourth data transmitting module, configured to receive fourth input data and to generate a fourth updating request based on fourth updating information;
a fourth monitoring module, configured to modify the fourth updating information according to the fourth updating request;
a fifth data transmitting module, configured to receive fifth input data and to generate a fifth updating request based on fifth updating information;
a fifth monitoring module, configured to modify the fifth updating information according to the fifth updating request;
a sixth data transmitting module, configured to receive one of the fourth updating request and the fifth updating request; and
wherein the second arbitrating module generates the second arbitrating command according to one of the first updating request and the second updating request, and one of the fourth updating request and the fifth updating request, which is applied as the another updating request;
wherein the first data transmitting module, the first monitoring module, the second data transmitting module, the second monitoring module and the third data transmitting module are provided in the first die;
wherein the fourth data transmitting module, the fourth monitoring module, the fifth data transmitting module, the fifth monitoring module and the sixth data transmitting module are provided in the second die.

8. The network switch of claim 1, further comprising:
a second data transmitting module, configured to receive second input data and to generate a second updating request based on second updating information;
a second monitoring module, configured to modify the second updating request according to the second updating information;
a third data transmitting module, configured to receive one of the first updating request and the second updating request;
a fourth data transmitting module, configured to receive fourth input data and to generate a fourth updating request based on fourth updating information;
a fourth monitoring module, configured to modify the fourth updating information according to the fourth updating request;
a fifth data transmitting module, configured to receive fifth input data and to generate a fifth updating request based on fifth updating information;
a fifth monitoring module, configured to modify the fifth updating information according to the fifth updating request;
a sixth data transmitting module, configured to receive one of the fourth updating request and the fifth updating request; and
a seventh data transmitting module, configured to receive one of the first updating request and the second updating request, and one of the fourth updating request and the fifth updating request;
wherein one of the first updating request, the second updating request, the fourth updating request and the fifth updating request is applied to update the date base.

9. The network switch of claim 1, wherein the data base is a MAC address table.

10. The network switch of claim 1, wherein the first data transmitting module is a pipe line module.

11. A network switch, comprising:
a first die, configured to generate first die updating request;
a second die, configured to generate second die updating request;
a data transmitting module, configured to receive the first die updating request and the second die updating request; and
an arbitrating module, configured to generate an arbitrating command to allocate data base addresses to be updated for a data base according to the first die updating request and the second die updating request.

12. The network switch of claim 11, wherein the data base is a MAC address table.

13. A data base updating method, comprising:
generating a first updating request based on first updating information, wherein the first updating request indicates which address of data base stored in a storage unit is requested to be updated; and
modifying the first updating information according to the first updating request.

14. The data base updating method of claim 13, further comprising:
generating a second updating request based on second updating information;
modifying the second updating information according to the second updating request;
generating a first arbitrating command according to the first updating request and the second updating request;
wherein the first arbitrating command is applied to update the data base.

15. The data base updating method of claim 14, further comprising:
generating a third updating request according to the first arbitrating command, further comprising:
generating a second arbitrating command according to the third updating request and an external updating request;
wherein the second arbitrating command is applied to update the data base.

16. The data base updating method of claim 15, further comprising:
generating a fourth updating request based on fourth updating information;
modifying the fourth updating information according to the fourth updating request;
generating a fifth updating request based on fifth updating information;
modifying the fifth updating information according to the fifth updating request;
generating the third arbitrating command according to the fourth updating request and the fifth updating request; and
generating the external updating request according to a third arbitrating command, the fourth updating request and the fifth updating request.

17. The data base updating method of claim 13, further comprising:
generating a second updating request based on second updating information;
modifying the second updating information according to the second updating request; and
generating a second arbitrating command according to an external updating request and one of the first updating request and the second updating request;
wherein the second arbitrating command is applied to update the data base.

18. The data base updating method of claim 13, wherein the data base is a MAC address table.

19. A data base updating method, comprising:
acquiring first die updating request for a first die and a second die updating request for a second die; and
generating an arbitrating command to allocate data base addresses to be updated for a data base according to the first die updating request and the second die updating request.

20. The data base updating method of claim 19, wherein the data base is a MAC address table.
